(19) United States
(12) Patent Application Publication
(10) Pub. No.: US 2015/0019089 A1
(43) Pub. Date: Jan. 15, 2015

(54) DATA MONITORING SYSTEM FOR FINAL DRIVE

(71) Applicant: Caterpillar Inc., Peoria, IL (US)

(72) Inventors: Daniel J. Reed, Brimfield, IL (US); Ryan E. Stange, Henry, IL (US)

(73) Assignee: Caterpillar Inc., Peoria, IL (US)

(21) Appl. No.: 14/501,064

(22) Filed: Sep. 30, 2014

(51) Int. Cl. F16H 61/02; F16H 57/08

(52) U.S. Cl. CPC F16H 61/0202; F16H 57/08
USPC 701/51

(57) ABSTRACT

A data monitoring system for a final drive is disclosed. The final drive includes a first planetary gear assembly and a cover plate. The data monitoring system includes a first probe, a second probe, a data acquisition system, a wireless router, and an engagement member. The first probe and the second probe generate a first and second electric signal that corresponds to a radial and axial movement of the first planetary carrier, respectively. The data monitoring system is mounted on the cover plate, receives the first and second electric signal, and calculates positional data of the first planetary carrier. The wireless router is mounted on the cover plate, receives the positional data from the data acquisition system, and transmits it to a remote device. The engagement member is configured to transfer electrical power from a power source to the data monitoring system.

### TECHNICAL FIELD

The present disclosure relates generally to a final drive of an electrically driven machine. More specifically, the present disclosure relates to a data monitoring system for the final drive.

### BACKGROUND

Various machines, such as construction machines, are known to employ an electric drive system for propulsion. An electric drive system may include an electric motor that may be connected to wheels of the machine. The electric motor may be connected to each of the wheels of the machine via a final drive. The final drive provides high rotational speed reduction between the electric motor and the wheels of the machine.

The final drive may employ a combination of a first planetary gear assembly and a second planetary gear assembly. Planetary gear assemblies are used to obtain high speed reduction ratios. The first planetary gear assembly includes a planetary carrier that may become displaced radially and/or axially under dynamic load operations. The radial and axial displacement of the planetary carrier may result in field failures. Therefore, the radial and axial movement of the planetary carrier is monitored by a data monitoring system.

Conventional data monitoring systems may obtain positional data from the rotating components, and transfer the positional data to a remote device, to be later read by an operator. The transfer of data from the rotating components to the remote device may occur via electric contacts. However, these electric contacts may be subjected to failure, and therefore the data transfer may be unreliable and may be of poor quality. Also, conventional data monitoring systems may require a high number of channels to transmit data, which may require a complex and high-cost data monitoring system.

U.S. Pat. No. 8,171,791 discloses a rotational sensor mounted on a rim of a wheel. Although the rotational sensor is efficient in the determination of the rotational speed of the wheel, it uses an inbuilt battery system for generation of power. The use of inbuilt battery system for power requirement may require frequent charging problems associated with the rotational sensor.

### SUMMARY OF THE INVENTION

Various aspects of the present disclosure are directed to a data monitoring system for a final drive. The final drive has a first planetary gear assembly and a cover plate. The first planetary gear assembly includes a first planetary carrier that rotates in a direction opposite the rotation of the cover plate. The data monitoring system includes a first probe, a second probe, a data acquisition system, a wireless router, and an engagement member. The first probe is configured to generate a first electric signal that corresponds to a radial movement of the first planetary carrier of the first planetary gear assembly. The second probe is configured to generate a second electric signal that corresponds to an axial movement of the first planetary carrier of the first planetary gear assembly. The data acquisition system is mounted on the cover plate of the final drive and is in an electrical connection with the first probe and the second probe. The data acquisition system is configured to receive the first electric signal and the second electric signal. The data acquisition system calculates positional data associated with the first planetary carrier based on the first electric signal and the second electric signal. The wireless router is mounted on the cover plate of the final drive and is electrically connected with the data acquisition system. The wireless router is configured to receive the positional data from the data acquisition system and transmits the positional data to a remote device. The engagement member is configured to transmit electrical power from a power source to the first probe, the second probe, the data acquisition system, and the wireless router.

### BRIEF DESCRIPTION OF THE DRAWINGS

FIG. 1 is a sectional side view of a portion of an electric drive system of a machine, illustrating a final drive, in accordance with the concepts of the present disclosure;

FIG. 2 is a perspective view of a portion of the final drive as shown in FIG. 1, illustrating a data monitoring system in accordance with the concepts of the present disclosure; and

FIG. 3 is a block diagram of the data monitoring system as shown in FIG. 2, illustrating the transfer of positional data between various components of the data monitoring system.

### DETAILED DESCRIPTION

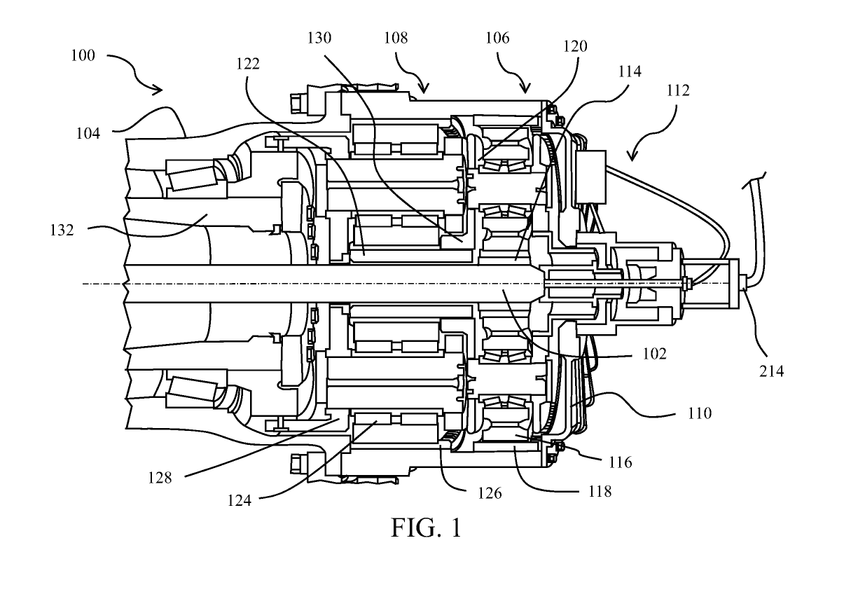

Reference will now be made in detail to specific embodiments or features, examples of which are illustrated in the accompanying drawings. Referring to FIG. 1, there is shown a final drive 100 used to obtain high speed reduction ratios in a machine propelled by an electric motor (not shown). The final drive 100 is driven by an axle shaft 102, operatively connected to the electric motor (not shown). The final drive 100, in turn, is adapted to rotate a wheel hub assembly 104, which is connected to the final drive 100. The final drive 100 may include a first planetary gear assembly 106, a second planetary gear assembly 108, a cover plate 110, and a data monitoring system 112.

The first planetary gear assembly 106 is positioned outward of the second planetary gear assembly 108, and may be directly driven by the axle shaft 102. The first planetary gear assembly 106 includes a first sun gear 114, a first set of planet gears 116, a first ring gear 118, and a first planetary carrier 120. The first sun gear 114 is directly attached to the axle shaft 102, which is driven by the axle shaft 102. The first sun gear 114 meshes with the first set of planet gears 116 which, in turn, meshes with the first ring gear 118. Further, the first set of planet gears 116 are supported by the first planetary carrier 120, as shown in FIG. 1. The first sun gear 114, the first set of planet gears 116, the first ring gear 118, and the first planetary carrier 120 are arranged in a manner, such that a rotational movement of the first sun gear 114 corresponds to a rotational movement of the first planetary carrier 120.

The second planetary gear assembly 108 also includes a second sun gear 122, a second set of planet gears 124, a second ring gear 126, and a second planetary carrier 128. The second sun gear 122, the second set of planet gears 124, the second ring gear 126, and the second planetary carrier 128 of the second planetary gear assembly 108, are in similar arrangement with each other as the first planetary gear assembly 106.

The second planetary gear assembly 108 is connected to the first planetary gear assembly 106, to be driven by the first planetary gear assembly 106. More particularly, the second sun gear 122, is connected to the first planetary carrier 120, via a spline arrangement 130, to drive the second planetary gear assembly 108. Therefore, a rotational motion of the first planetary carrier 120 is transferred to the second sun gear 122. This enables rotation of the second set of planet gears 124, supported by the second planetary carrier 128. The second planetary carrier 128, in turn, may be attached to a spindle assembly 132 and, as such, may remain relatively stationary. As the second planetary carrier 128 remains relatively stationary, a rotational movement of the second set of planet gears 124 corresponds to a rotational motion of the second ring gear 126. Further, the second ring gear 126 is attached to the wheel hub assembly 104, upon which a wheel (not shown) is mounted to rotate along with the wheel hub assembly 104.

The cover plate 110 is installed to protect the first planetary gear assembly 106 and the second planetary gear assembly 108 from external harsh environments. The cover plate 110 is fixedly attached to the second ring gear 126, and rotates in a direction opposite to rotation of the first planetary carrier 120. It may be appreciated that the cover plate 110 may be attached to the second ring gear 126 by bolting, welding, riveting, and/or any suitable arrangements thereof.

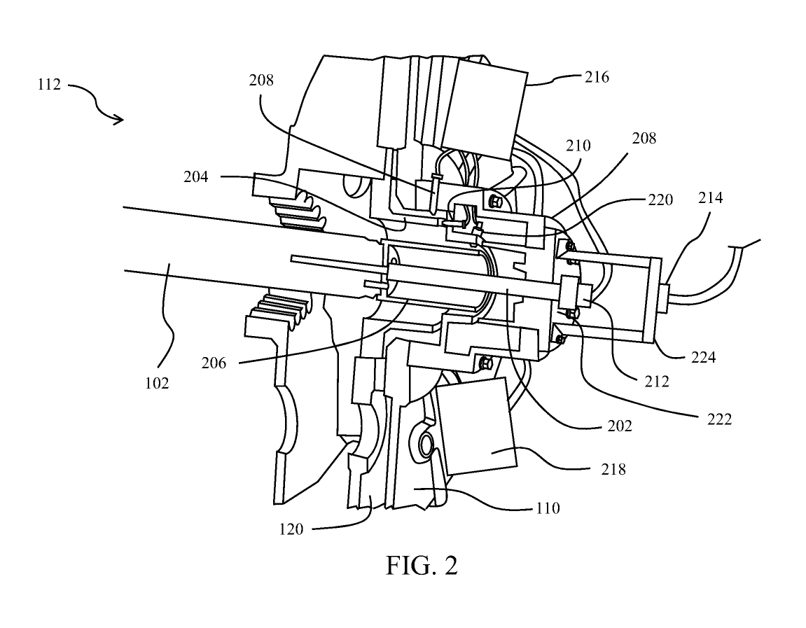

The data monitoring system 112 is installed to monitor a positional data associated with the first planetary carrier 120. The positional data may include a displacement of the first planetary carrier 120 radially and/or axially from its reference position. The reference position mentioned herein refers to the initial position of the first planetary carrier 120, when it is suitably arranged with the second planetary gear assembly 108. The mounting and structural arrangement of the data monitoring system 112 is best described in FIG. 2, as disclosed below.

Referring to FIG. 2, there is shown the data monitoring system 112, for monitoring of the positional data of the first planetary carrier 120 of the final drive 100 (as shown in FIG. 1). The data monitoring system 112 includes an axle quill shaft 202, a carrier extension 204, a probe housing 206, a first probe 208, a second probe 210, an attachment member 212, an engagement member 214, a data acquisition system 216, and a wireless router 218.

The axle quill shaft 202 is fixedly attached to the axle shaft 102, and therefore replicates the motion of the axle shaft 102. The axle quill shaft 202 may be attached to the axle shaft 102 by bolting, welding, riveting, and/or any other suitable arrangement thereof.

The carrier extension 204 is a substantially hollow cylinder fixedly attached to the first planetary carrier 120 of the first planetary gear assembly 106, and shares a common longitudinal axis X-X with the axle quill shaft 202. The carrier extension 204 is fixedly attached to the first planetary carrier 120 and replicates the motion of the first planetary carrier 120. It may be understood that the positional data of the first planetary carrier 120 can be measured by measuring a positional data of the carrier extension 204.

The probe housing 206 may also be a hollow structural arrangement that covers the carrier extension 204. The probe housing 206 is fixedly attached to the cover plate 110, and shares the longitudinal axis X-X with the axle quill shaft 202 and the carrier extension 204. The probe housing 206 provides a mounting base for the first probe 208, and the second probe 210, and is covered by a thrust bearing cover 222. The probe housing 206 includes a plurality of probe seats (not shown), where the first probe 208, and the second probe 210 may be mounted.

The first probe 208 is mounted in one of the plurality of probe seats (not shown) within the probe housing 206, such that, the first probe 208 faces an outer periphery of the carrier extension 204. The first probe 208 may be an inductive current probe that generates a first signal corresponding to a radial movement of the carrier extension 204.

The second probe 210 is mounted in one of the plurality of probe seats (not shown) within the probe housing 206, such that, the second probe 210 faces a free end of the carrier extension 204. Therefore, the second probe 210 is installed in the probe housing 206 while forming a right angle with the first probe 208. The second probe 210 may also be an inductive current probe that generates a second signal corresponding to an axial movement of the carrier extension 204.

In an embodiment, a third probe 220 is mounted in another probe seat (not shown) within the probe housing 206 so that the third probe 220 faces a free end of the axle shaft 102. More specifically, the third probe 220 is in planar arrangement with the first probe 208 and the second probe 210. The third probe 220 may be similar in construction and mounting as that of the first probe 208 and the second probe 210. The third probe 220 is adapted to raise a third signal corresponding to a radial movement of the axle shaft 102. The third signal may further be read by the data acquisition system 216 to determine positional data associated with the axle shaft 102.

The attachment member 212 may be a slip ring, mounted directly onto the axle quill shaft 202. The attachment member 212 is adapted to route wires of a strain gauge from the final drive 100 to the data acquisition system 216. The strain gauge in turn is adapted to measure the rotational data associated with the axle quill shaft 202. The rotational data may include rotational speed, rotational torque, and the like.

The engagement member 214 is installed over the thrust bearing cover 222 via an Extension mount 224. More specifically, the Extension mount 224 is fixedly attached to the thrust bearing cover 222 extending away from the thrust bearing cover 222 and the engagement member 214 is then installed over the Extension mount 224. The engagement member 214 is connected to a DC (direct current) power supply at one end and is adapted to transfer electrical power from a stationary power source to each of the first probe 208, the second probe 210, the data acquisition system 216, and the wireless router 218.

The data acquisition system 216 is mounted on to the cover plate 110 of the final drive 100, and is in an electrical connection with the first probe 208, the second probe 210. The data acquisition system 216 may be an electrical assembly of a number of electrical components that receive and process electric signals, to output a relevant data. The data acquisition system 216, which is in electrical connection to the first probe 208 and the second probe 210, receives the first electrical signal and the second electrical signal. Also, the data acquisition system 216 may calculate the positional data associated with the first planetary carrier 120, based on the first and second electrical signal.

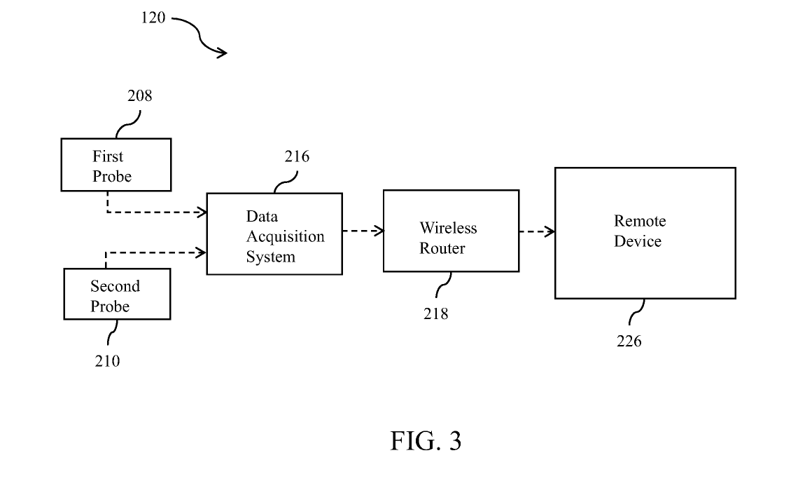

The wireless router 218 is also mounted on the cover plate 110 of the final drive 100, and is in electrical communication with the data acquisition system 216. Further, the wireless router 218 is in wireless communication with a Remote device 226 (FIG. 3), such as a laptop and/or remotely placed desktop. The wireless router 218 is capable of receiving the positional data from the data acquisition system 216 and wirelessly transfer the positional data to the Remote device 226 (FIG. 3).

Referring to FIG. 3, there is shown a block diagram of the data monitoring system 112, illustrating the transfer of positional data between various components of the data monitoring system 112. In application, the first probe 208 generates the first electric signal corresponding to the radial movement of the first planetary carrier 120. Simultaneously, the second probe 210 generates the second signal that corresponds to axial movement of the first planetary carrier 120. The first signal and the second signal are transmitted to the data acquisition system 216 mounted onto the cover plate 110. The data monitoring system 112 calculates the positional data based on the first and second electrical signals. The wireless router 218 then receives the positional data from the data monitoring system 112, and wirelessly transmits the positional data to the Remote device 226. At the remote device 226, a user can monitor the positional data and determine the working condition of the final drive 100.

### INDUSTRIAL APPLICABILITY

In operation, the axle shaft 102 provides input to the final drive 100, and output is obtained at the wheel hub assembly 104, after a reduction in rotational speed. The axle shaft 102 rotates the first sun gear 114 of the first planetary gear assembly 106, which, in turn, rotates the first set of planet gears 116. A rotation of the first set of planet gears 116 enables rotation of the first planetary carrier 120. As the first planetary carrier 120 is attached to the second sun gear 122, the second sun gear 122 along with the first planetary carrier 120. The rotation of the second sun gear 122 enables a rotation of the second set of planet gears 124. As the second planetary carrier 128 is stationary, the rotation of the second set of planet gears 124 corresponds to rotation of the second ring gear 126. Further, since the second ring gear 126 is attached to the wheel hub assembly 104, it rotates the wheel hub assembly 104 and the wheel (not shown) connected thereto.

Under dynamic loads, the first planetary carrier 120 may displace radially and/or axially from its reference position. The positional data of the first planetary carrier 120 is monitored by the data monitoring system 112.

The first probe 208 of the data monitoring system 112 generates a first signal corresponding to a radial displacement of the carrier extension 204 from its reference position. The first signal may be a measure of change in an electrical quantity of the first probe 208, such as but not limited to, an electric power, back electromotive voltage, electric current, and the like.

Similarly, the second probe 210 generates the second electric signal that corresponds to axial displacement of the carrier extension 204. The first electric signal and the second electric signal are used by the data acquisition system 216 to determine the positional data of the carrier extension 204.

The data acquisition system 216 receives the first electric signal and the second electric signal, and calculates the positional data based on a strength of the first and second electric signals. The strength of the first and second electric signal is a measure of change in voltage of the corresponding probes.

Thereafter, the wireless router 218 receives the positional data from the data acquisition system 216 and wirelessly transfers the positional data to the Remote device 226. A wireless transmission of data has lesser number of mechanical connections, and therefore is least liable to failure. This makes wireless transmission reliable and accurate. Also, the wireless transfer of data may require a limited number of channels for the transfer of data. This makes the data monitoring system 112 less complex and less cumbersome to use in the determination of the positional data.

It should be understood that the above description is intended for illustrative purposes only and is not intended to limit the scope of the present disclosure in any way. Those skilled in the art will appreciate that other aspects of the disclosure may be obtained from a study of the drawings, the disclosure, and the appended claim.

What is claimed is:

1. A data monitoring system for a final drive, the final drive having a first planetary gear assembly, and a cover plate, wherein the first planetary gear assembly includes a first planetary carrier adapted to rotate in a direction opposite to a rotation of the cover plate, the data monitoring system comprising:
a first probe configured to generate a first electric signal corresponding to a radial movement of the first planetary carrier of the first planetary gear assembly;
a second probe configured to generate a second electric signal corresponding to an axial movement of the first planetary carrier of the first planetary gear assembly;
a data acquisition system mounted on the cover plate of the final drive and in an electrical connection with the first probe and the second probe, the data acquisition system configured to receive the first electric signal and the second electric signal, and calculate a positional data associated with the first planetary carrier based on the first electric signal and the second electric signal;
a wireless router mounted on the cover plate of the final drive and electrically connected with the data acquisition system, the wireless router configured to receive the positional data from the data acquisition system and transmit the positional data to a remote device; and
an engagement member configured to transfer electrical power from a power source to the first probe, the second probe, the data acquisition system, and the wireless router.
